(19) United States
(12) Patent Application Publication
(10) Pub. No.: US 2025/0055551 A1
(43) Pub. Date: Feb. 13, 2025

(54) SYSTEMS AND METHODS FOR USER EQUIPMENT INITIATED LINK MANAGEMENT

(71) Applicant: Huawei Technologies Co., Ltd., Shenzhen (CN)

(72) Inventors: Xi Zhang, Ottawa (CA); Chunyang Lei, Kanata (CA); Xiaobo Chen, Kanata (CA); Jianglei Ma, Ottawa (CA)

(21) Appl. No.: 18/926,001

(22) Filed: Oct. 24, 2024

Related U.S. Application Data
(63) Continuation of application No. PCT/CN2022/089183, filed on Apr. 26, 2022.

(51) Int. Cl. H04B 7/06; H04W 72/044; H04W 72/542

(52) U.S. Cl. CPC H04B 7/06966; H04W 72/046; H04W 72/542

(57) ABSTRACT

Aspects of the present disclosure provide solutions to UE-initiated beam switching, beam pair switching, or link switching based on use of an association of at least two types of reference signals. The at least two types of reference signals include, but are not limited to, a beam management reference signal (BM-RS), a tracking reference signal (T-RS) and a channel state information acquisition reference signal (CSIA-RS).

### CROSS REFERENCE

The application is a continuation of International Application No. PCT/CN2022/089183, filed on Apr. 26, 2022, the disclosure of which is hereby incorporated by reference in its entirety.

### TECHNICAL FIELD

The present disclosure relates generally to wireless communications, and in particular embodiments, systems and methods for user equipment (UE) initiated link management.

### BACKGROUND

In some wireless communication systems, user equipments (UEs) wirelessly communicate with a base station (for example, NodeB, evolved NodeB or gNB) to send data to the base station and/or receive data from the base station. A wireless communication from a UE to a base station is referred to as an uplink (UL) communication. A wireless communication from a base station to a UE is referred to as a downlink (DL) communication. A wireless communication from a first UE to a second UE is referred to as a sidelink (SL) communication or device-to-device (D2D) communication.

Resources are required to perform uplink, downlink and sidelink communications. For example, a base station may wirelessly transmit data, such as a transport block (TB), to a UE in a downlink transmission at a particular frequency and over a particular duration of time. The frequency and time duration used are examples of resources.

In some wireless communication systems, beamforming is used in which a communication signal is transmitted in a particular direction instead of being transmitted omni-directionally. High frequency communication is a technology that may improve the performance (i.e. improve data rate) of future cellular networks due to a large bandwidth for communication. However, the higher the frequency involved the larger propagation pathloss involved. Therefore, more antennas may be needed in multiple-input multiple-output (MIMO) systems to facilitate the high frequency communication (e.g. by improving signal to noise ratio (SNR) at the receiver).

Beamforming can be performed at a base station (BS), user equipment (UE), or both. To extend coverage at millimeter wave (mmWave) frequency bands or in Frequency Range 2 (FR2), analog beamforming is typically adopted at both the BS and the UE. FIG. 1 shows a base station 10 with a beam 15 directed toward a UE 15 and the UE 20 has a beam 25 directed at the base station 10. The combination of beams 15 and 25 may be considered a beam pair. A beam pair includes a transmit beam at one side of a communication link and a receive beam at the other side of the communication link.

When beamforming is used at the UE, the UE may have better knowledge as to whether an update is needed or not, for example handover to another base station or using a different receive beam at the UE. Beam tracking may be a functionality used by the UE to make informed decisions about selecting a different beam or beam pair. In order to expedite a beam tracking process, a UE may initiate beam management procedures, including beam measurement, reporting, and also beam switching for a beam pair and/or link switching. After switching to a new beam, beam pair, or more generally a new link, continuous channel tracking and acquiring the latest channel state information (CSI) of a new beam, beam pair, or link may incur additional latency and overhead if not handled properly. In other words, simply allowing the UE to initiate beam switching is not necessarily sufficient for smooth mobility support in multi-beam systems.

Beam prediction may potentially reduce the latency for beam switching and thereby fluctuations experienced in link quality. Beam prediction may be performed at the base station or the UE, or both. However, coordination may be needed between the base station and UE. Without appropriate coordination, efficiency of beam prediction can hardly be guaranteed.

### SUMMARY

Aspects of the present disclosure propose merging channel tracking and CSI acquisition with a UE-initiated beam selection process, so that link adaptation after beam switching may have less latency and may be more reliable. Some aspects of the present disclosure also propose methods to align beam prediction behavior between the base station and the UE, so that one device may have additional knowledge of possible actions at the other device. Some aspects of the present disclosure also provide methods for the UE to initiate beam or link switching that information regarding triggering conditions and timing, for example if and when predictive beam switching or link switching may be used.

According to an aspect of the disclosure, there is provided a method involving: receiving, by a user equipment (UE), an indication of an association between at least two of: a beam measurement reference signal (BM-RS); a tracking reference signal (T-RS); and a channel state information acquisition reference signal (CSIA-RS); selecting, by the UE, a new link for link switching based on measurements of at least one of the BM-RS, the T-RS, and CSIA-RS; and transmitting, by the UE, an indication of link switching to a base station that includes an indication of the new link and feedback information pertaining to the new link based on the measurements of the at least one of the BM-RS, the T-RS, and CSIA-RS.

In some embodiments, the method further involves receiving, by the UE, a physical downlink control channel (PDCCH) or a physical downlink shared channel (PDSCH) from the base station on the new link.

In some embodiments, the association between the at least two of the BM-RS, the T-RS, and the CSIA-RS is, between any two types of the reference signals, a one-to-one association, a one-to-many association or a many-to-one association.

In some embodiments, the method further involves performing measurements, by the UE, of at least two of the BM-RS, the T-RS, and CSIA-RS based on the indication of the association.

In some embodiments, performing measurements of the BM-RS involves measuring the BM-RS and determining a reference signal received power (RSRP) or a signal-to-interference-plus-noise ratio (SINR); performing measurements of the T-RS comprises tracking the T-RS and determining large-scale parameters of the channel for the new link on which the T-RS is monitored, wherein the large-scale parameters include one or more of: average delay; delay spread; Doppler shift; and Doppler spread; and performing measurements of the CSIA-RS comprises estimating the channel state information (CSI) of the channel for the new link on which the CSIA-RS is received based on one or more of: rank indicator (RI); channel quality indicator (CQI); precoding matrix indicator (PMI); and layer indicator (LI).

In some embodiments, the method further involves receiving, by the UE, confirmation from the base station of the indication of link switching transmitted by the UE.

In some embodiments, the method further involves updating, by the UE, PDCCH quasi co-location (QCL) or PDSCH QCL based on the new link.

In some embodiments, the selecting the new link for link switching involves one of: selecting a link with lowest Doppler shift or Doppler spread among candidate links with RSRP or SINR above a threshold value; selecting a link with a highest predicted data rate determined from measured CSI among candidate links with RSRP or SINR above a threshold value; selecting a link with a highest predicted data rate determined from measured CSI among candidate links with RSRP or SINR above a threshold and Doppler shift or Doppler spread below a threshold value; and selecting a link with a highest measured RSRP or SINR or RI or CQI.

In some embodiments, the method further involves determining, by the UE, the association between at least two types of the reference signals based on the received indication of the association.

In some embodiments, the method further involves the received indication includes at least one of: an indication that the T-RS is quasi co-located (QCLed) to the BM-RS; and an indication that the UE derive association for UE-initiated link switching based on already indicated QCL relations.

In some embodiments, the method further involves receiving, by the UE, an indication as to whether the UE is allowed to perform link prediction when selecting the new link for link switching.

In some embodiments, the indication indicates that the UE is allowed to perform link prediction, receiving, by the UE, an indication of a maximum value of time offset for a predicted link relative to a latest measurement occasion.

In some embodiments, the indication of link switching to the base station comprises an indication that the new link and the feedback information pertaining to the new link are based on prediction results.

In some embodiments, the method further involves transmitting, by the UE, at least one of: a time stamp indicating when the link is predicted to have a corresponding quality identified in the feedback information; and a confidence level used in link prediction.

In some embodiments, the method further involves selecting, by the UE, the new link for link switching using beam or link prediction results.

According to an aspect of the disclosure, there is provided a method involving: selecting, by a UE, a new link for link switching based on measurements of at least one of a BM-RS; a T-RS; and a CSIA-RS and prediction results of link quality for a time in the future; and transmitting, by the UE, an indication of link switching to a base station that includes an indication of a new link and feedback information pertaining to the new link based on measurements of at least one of the BM-RS, the T-RS, and the CSIA-RS, and the prediction results, and wherein the indication is transmitted on a sporadic uplink transmission requested by the UE or a periodic uplink transmission configured by the base station.

In some embodiments, the method further involves determining whether to initiate link switching based on at least one of: how fast the link quality is changing; and reporting periodicity when periodic uplink transmission is configured by the base station.

In some embodiments, when transmitting the indication of link switching to the base station, transmitting, by the UE, an indication that the new link and the feedback information pertaining to the new link are based on prediction.

In some embodiments, the method further involves transmitting, by the UE, at least one of: a time stamp indicating when the link is predicted to have a corresponding quality identified in the feedback information; and a confidence level used in link prediction.

In some embodiments, the method further involves selecting, by the UE, the new link for link switching using beam or link prediction results.

According to an aspect of the disclosure, there is provided a method involving: selecting, by a UE, a new link for link switching based on measurements of at least one of a BM-RS, a T-RS, and a CSIA-RS and prediction results of link quality for a time in the future, wherein the selecting the new link for link switching comprises selecting, by the UE, the new link based on the new link having a link quality that is within a threshold value of at least one current link quality; and transmitting, by the UE, an indication of link switching comprising an indication of the new link and the feedback information pertaining to the new link.

According to an aspect of the disclosure, there is provided an apparatus including a processor and a computer-readable medium. The computer-readable medium has stored thereon computer executable instructions that when executed by the processor cause the apparatus to perform any of the methods described above.

According to an aspect of the disclosure, there is provided a method involving: transmitting, by a base station, an indication of an association between at least two of: a BM-RS; a T-RS; and a CSIA-RS; receiving, by the base station, an indication of link switching from a UE that includes an indication of a new link and feedback information pertaining to the new link based on measurements performed at the UE of at least one of the BM-RS, the T-RS, and CSIA-RS.

In some embodiments, the method further involves transmitting information, by the base station, a PDCCH or a PDSCH to the UE on the link.

In some embodiments, the association between the at least two of the BM-RS, the T-RS, and the CSIA-RS is, between any two types of the reference signals, a one-to-one association, a one-to-many association or a many-to-one association.

In some embodiments, the method further involves transmitting, by the base station, confirmation of the indication of link switching received from the UE.

In some embodiments, the method further involves the indication of the association between the at least two types of reference signals is: an explicitly disclosed association between the at least two types of reference signals; or an implicitly disclosed association between the at least two types of reference signals to be used by the UE to determine the association between the at least two types of reference signals.

In some embodiments, the implicitly disclosed association comprises at least one of: an indication that the T-RS is QCLed to the BM-RS; and an indication that the UE derive association for UE-initiated link switching based on already indicated QCL relations.

In some embodiments, the method further involves transmitting, by the base station, an indication as to whether the UE is allowed to perform link prediction when selecting the new link for link switching.

In some embodiments, when the indication indicates that the UE is allowed to perform link prediction, transmitting, by the UE, an indication of a maximum timeframe value of time offset for a predicted link relative to a latest measurement occasion.

In some embodiments, the indication of link switching from the UE involves an indication that the new link and the feedback information pertaining to the new link are based on prediction results.

In some embodiments, the method further involves receiving, by the base station, at least one of: a time stamp indicating when the link is predicted to have a corresponding quality identified in the feedback information; and a confidence level used in link prediction.

According to an aspect of the disclosure, there is provided a method involving: receiving, by a base station, an indication of link switching from a user equipment (UE) that includes an indication of a new link and feedback information pertaining to the new link based on measurements performed at the UE of at least one of a beam measurement reference signal (BM-RS); a tracking reference signal (T-RS), and prediction results of link quality for a time in the future, and wherein the indication is received on a sporadic uplink transmission requested by the UE or a periodic uplink transmission configured by the base station.

In some embodiments, the method further involves the indication of link switching is based on at least one of: how fast the link quality is changing; and reporting periodicity when periodic uplink transmission is configured by the base station.

According to an aspect of the disclosure, there is provided a method involving: receiving, by the base station, an indication of link switching from a user equipment (UE) that includes an indication of a new link and feedback information pertaining to the new link based on measurements performed at the UE of at least one of a beam measurement reference signal (BM-RS); a tracking reference signal (T-RS); and a channel state information acquisition reference signal (CSIA-RS), and prediction results of link quality for a time in the future, wherein the indication of link switching is based on the new link having a link quality that is within a threshold value of at least one current link quality.

According to an aspect of the disclosure, there is provided an apparatus including a processor and a computer-readable medium. The computer-readable medium has stored thereon computer executable instructions that when executed by the processor cause the apparatus to perform any of the methods described above.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of beamforming used by a base station and a UE.

FIG. 2A is a schematic diagram of a communication system in which embodiments of the disclosure may occur.

FIG. 2B is another schematic diagram of a communication system in which embodiments of the disclosure may occur.

FIG. 3 is a block diagram illustrating units or modules in a device in which embodiments of the disclosure may occur.

FIG. 4 is a block diagram illustrating units or modules in a device in which embodiments of the disclosure may occur.

FIG. 5 is a block diagram illustrating an association between a beam measurement reference signal (BM-RS), a tracking reference signal (T-RS), and a channel state information acquisition reference signal (CSIA-RS) for multiple different beams according to an aspect of the disclosure.

FIG. 6 is a block diagram illustrating various examples of associations between BM-RS, T-RS, and CSIA-RS according to an aspect of the disclosure.

FIG. 7 is a block diagram illustrating sets of BM-RS, T-RS, and CSIA-RS and how respective reference signals are associated with one another according to an aspect of the disclosure.

FIG. 8 is an example of base station and UE operation including different types of UE-initiated link management including beam selection, channel tracking, channel state information acquisition, UE reporting and base station confirmation occurring over time when using reference signal association according to an aspect of the disclosure.

FIG. 9 is an example of configuration of an allowed time range for use of prediction according to an aspect of the disclosure.

FIG. 10 illustrates an example of reporting of a time stamp for a predicted beam, beam pair, or link according to an aspect of the disclosure.

FIG. 11 illustrates an example of UE-initiated predictive link switching with sporadic reporting according to an aspect of the disclosure.

FIG. 12 illustrates an example of UE-initiated predictive link switching with periodic reporting occasions according to an aspect of the disclosure.

FIG. 13 is a schematic diagram illustrating UE-initiated predictive link switching based on smooth transition according to an aspect of the disclosure.

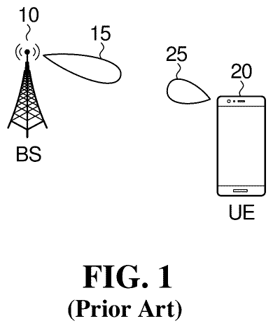

### DETAILED DESCRIPTION OF THE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Aspects of the present disclosure provide solutions to UE-initiated beam switching, beam pair switching, or link switching based on the use of an association of at least two types of reference signals. The at least two types of reference signals include, but are not limited to, a beam management reference signal (BM-RS), a tracking reference signal (T-RS) and a channel state information acquisition reference signal (CSIA-RS). The methods and devices provided herein may reduce latency and overhead that occur during channel tracking and channel state information (CSI) acquisition after UE-initiated beam, beam pair, or link switching. In addition, aspects of the present disclosure may reduce ambiguity between the base station and the UE pertaining to beam, beam pair, or link prediction behavior and may improve efficiency and reliability for UE initiated beam switching, beam pair switching, or link switching. When referring to any of beam switching, beam pair switching or link switching, it is to be understood that these expressions mean substantially the same thing.

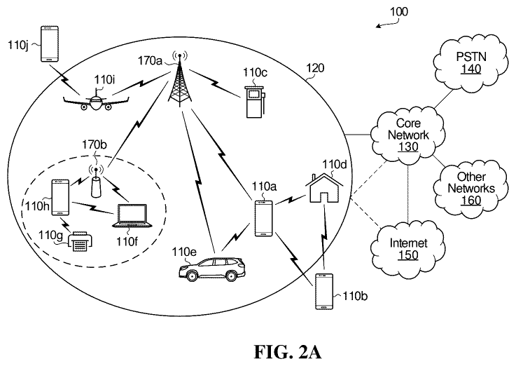

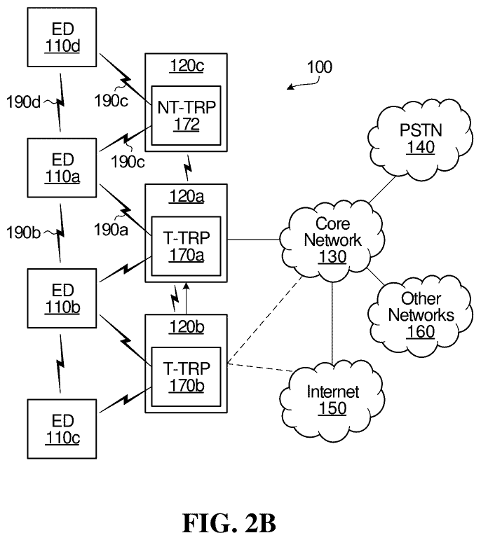

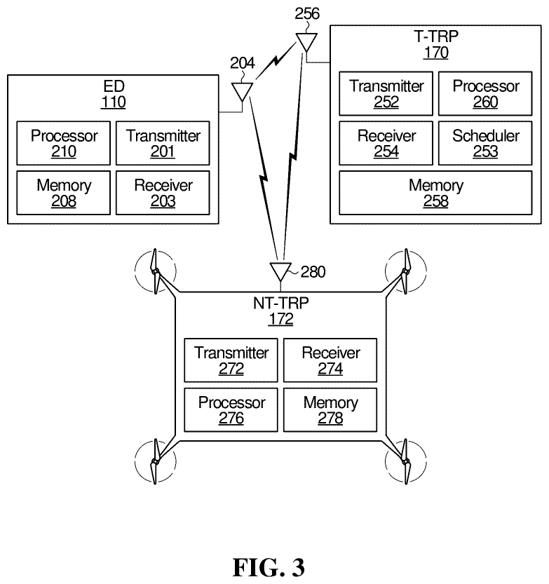

FIGS. 2A, 2B, and 3 following below provide context for the network and device that may be in the network and that may implement aspects of the present disclosure.

Referring to FIG. 2A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 2B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 2B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 2B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 2B, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 2B, the RANs 120a-120b include base stations 170a-170b, respectively. The base stations may also be referred to as transmit receive points (TRP) as labelled in FIG. 2B. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a site controller, an access point (AP), or a wireless router.

In some examples, one or more of the base stations 170a-170b may be a terrestrial base station, or terrestrial TRP (T-TRP), that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, 172, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 2B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110d over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b, 172 may implement Universal Mobile Telecommunication System (UMTS) Terrestrial Radio Access (UTRA) to establish an air interface 190a, 190c using wideband CDMA (WCDMA). In doing so, the base station 170a-170b, 172 may implement protocols such as High Speed Packet Access (HSPA), Evolved HSPA (HSPA+) optionally including High Speed Downlink Packet Access (HSDPA), High Speed Packet Uplink Access (HSPUA) or both. Alternatively, a base station 170a-170b, 172 may establish an air interface 190a, 190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110c communicate with one another over one or more sidelink (SL) air interfaces 190b,190d using wireless communication links e.g. radio frequency (RF), microwave, infrared (IR), etc. The SL air interfaces 190b,190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b,190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a reconfigurable intelligent surface (RIS). However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 3 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 2B, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 2A or 2B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

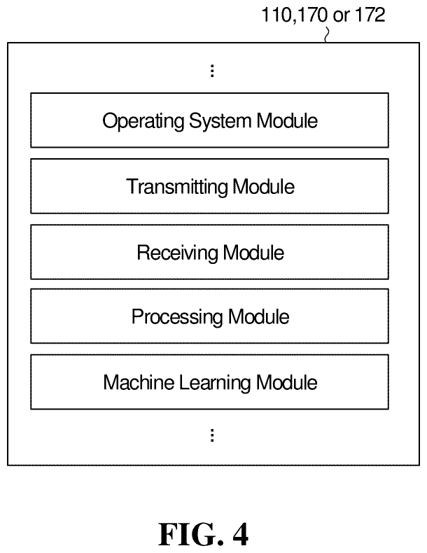

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent MCS, intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHZ, millimeter to Terahertz carrier frequency, from space, outdoor to indoor scenario, and from text, voice to video. These data collecting, processing and usage operations are performed in a unified framework or a different framework.

Some aspects of the present disclosure propose merging channel tracking and CSI acquisition with a UE-initiated beam selection process, so that link adaptation after beam switching may have less latency and may be more reliable. Some aspects of the present disclosure also propose methods to align beam prediction behavior between the base station and the UE, so that one device may have additional knowledge of possible actions at the other device. Some aspects of the present disclosure also provide methods for the UE to initiate beam or link switching that information regarding triggering conditions and timing, for example if and when predictive beam switching or link switching may be used.

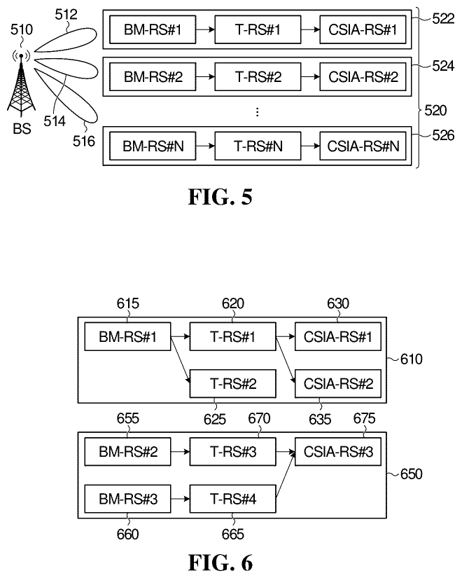

One aspect of the present disclosure is directed to establishing an association between parameters for beam measurement, channel tracking, and CSI acquisition. To be specific, the base station, or network that the base station is a part of, may provide an association, for example a mapping relation, between reference signals used for beam measurement, channel tracking and CSI acquisition (CSIA). The reference signal for beam measurement may be referred to as a beam measurement reference signal (BM-RS). The reference signal for channel tracking may be referred to as a channel tracking reference signal (T-RS). The reference signal for CSIA may be referred to as a CSIA reference signal (CSIA-RS). FIG. 5 illustrates an example of a set 520 of one-to-one mappings that may be used for beams 512, 514 and 516 of a base station 510. A first one-to-one mapping 522 of the set 520 for the first beam 512 includes an association between BM-RS #1, T-RS #1, and CSIA-RS #1. A second one-to-one mapping 524 of the set 520 for the second beam 514 includes an association between BM-RS #2, T-RS #2, and CSIA-RS #2. An nth one-to-one mapping 526 of the set 520 for the nth beam 516 includes an association between BM-RS #N, T-RS #N, and CSIA-RS #N.

A UE may perform beam measurement using the BM-RS identified in the mapping, then start channel tracking using the T-RS associated in the mapping with the selected BM-RS, and then measure CSI using the CSIA-RS associated with the selected BM-RS and/or TRS in the mapping. In this way, when the UE initiates beam switching to a selected new beam or beam pair, channel tracking is ongoing and the CSI is ready. For this reason, beam switching may be generalized and referred to as link switching, because channel tracking and CSI acquisition for the communication link occurring on this beam or beam pair have been included and taken into consideration in such switching procedure. In some embodiments, the beam selection at the UE may be performed based on link quality that is measured based on the BM-RS of a new beam, beam pair, or link. The measured link quality may be one or more parameter such as reference signal received power (RSRP) and signal-to-interference-plus-noise ratio (SINR).

In some embodiments, the UE may initiate beam switching to a new beam, beam pair or link based on the CSI obtained from the CSIA-RS associated with the selected BM-RS and/or T-RS, such as rank indicator (RI) and/or channel quality indicator (CQI) and/or an expected data rate assuming the corresponding rank and modulation and coding scheme (MCS) are to be used for subsequent data transmission. In some embodiments, the UE may initiate switching to a new beam, beam pair or link by sending a CSI report to the base station, which may in turn help expedite link adaptation for a selected new beam, beam pair, or link.

The BM-RS is a reference signal used for beam measurement. For example, the BM-RS may be a synchronization signal block (SSB), over which beam measurements, such as RSRP or SINR measurement, are performed. The BM-RS may be a channel state information reference signal (CSI-RS) configured for RSRP or SINR measurement. The CSI-RS may belong to a CSI-RS resource set that is configured for use based on a configuration parameter. An example of a configuration parameter is a 5G New Radio (NR) configuration parameter known as “repetition”. In 5G NR, when the “repetition” parameter is configured as “ON”, the UE assumes that the base station will transmit the CSI-RS resources in the CSI-RS resource set with the same spatial domain transmit filter, or the same beam, with which the UE can perform receive beam training by receiving the CSI-RS resources with different receive beams. The UE cannot make such an assumption if the parameter “repetition” is configured as “OFF”. The repetition parameter may be configured as a single bit field where a “1” is “ON” and a “o” is “OFF”, or vice versa.

T-RS is a reference signal that may be used for downlink (DL) time and frequency tracking. For example, the T-RS can be a CSI-RS configured for the purpose of tracking. The T-RS may belong to a CSI-RS resource set configured for use based on a configuration parameter. An example of a configuration parameter is a 5G NR configuration parameter known as “trs-Info”. In 5G NR, for a CSI-RS resource set configured using the parameter “trs-Info”, the UE may assume the CSI-RS resources in the CSI-RS resource set are transmitted using the same antenna port, with which the UE performs time and frequency tracking to estimate large-scale parameters such as average delay, delay spread, Doppler shift, and Doppler spread.

CSIA-RS is a reference signal that may be used for CSI acquisition. For example, the CSIA-RS may be a CSI-RS configured for measuring and reporting CSI. Examples of CSI include rank indicator (RI), channel quality indicator (CQI), precoding matrix indicator (PMI), and/or layer indicator (LI). With respect to this disclosure, beam related measurement and reporting (for parameters such as RSRP and/or SINR) and CSI related measurement and reporting (for parameters such as RI, CQI, PMI, and/or LI) are considered as two different categories. In some embodiments, beam related measurement and reporting may be alternatively considered and/or labelled as one type of CSI measurement, e.g., considering RSRP and/or SINR reporting as one type of CSI reporting. The three types of RS referred to are named from a functionality perspective. These RS may be different CSI-RSs configured for different functionalities, even though they may all be considered more generally as CSI-RS.

In some embodiments, the association or mapping between BM-RS, T-RS, and CSIA-RS may be one-to-multiple or multiple-to-one. As particular examples, one BM-RS may be mapped with multiple T-RS or one T-RS may be mapped with multiple CSIA-RS, or multiple T-RS may be mapped with one CSIA-RS.

FIG. 6 illustrates two different examples of sets of associations or mappings of BM-RS, T-RS, and CSIA-RS. In the first set 610 there is a one-to-multiple mapping between a BM-RS BM-RS #1 615 and two T-RS, T-RS #1 620 and T-RS #2 625. Also in the first set 610, there is a one-to-multiple mapping between T-RS #2 620 and two CSIA-RS, CSIA-RS #1 630 and CSIA-RS #2 635. In the second set 650 there is a one-to-one mapping between a first BM-RS BM-RS #2 655 and a first T-RS T-RS #3 670 and between a second BM-RS BM-RS #3 660 and a second T-RS T-RS #4 665. Also in the second set 650 there is a multiple-to-one mapping between T-RS #3 670 and T-RS #4 665 and a single CSIA-RS CSIA-RS #3 675.

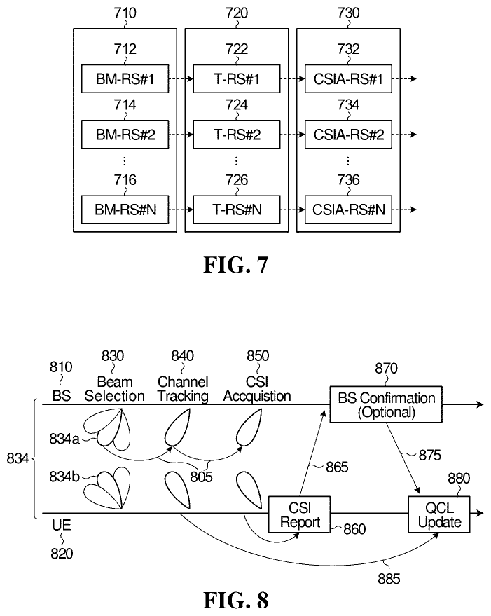

FIG. 7 illustrates an example in which there is a set 710 of BM-RSs, a set 720 of T-RSs, and a set 730 of CSIA-RSs. There is a first association between BM-RS #1 712, T-RS #2 722, and CSIA-RS #1 732, there is a second association between BM-RS #2 714, T-RS #2 724, and CSIA-RS #2 734, and a third association between BM-RS #N 716, T-RS #N 726, and CSIA-RS #N 736. When the association or mapping between the BM-RS, the T-RS, and the CSIA-RS is provided to a UE, the UE may perform beam selection based on the BM-RS that is indicated in the mapping. The selection of a new beam, beam pair, or link may be based on a value of a measurement such as RSRP or SINR. After selecting the new beam, beam pair, or link that corresponds to the one of the BM-RS, the UE may start tracking large-scale parameters of a downlink (DL) channel corresponding to the selected new beam, beam pair or link based on the T-RS that is associated with the selected BM-RS. The large-scale parameters may be parameters such as average delay, delay spread, Doppler shift, and Doppler spread. Subsequent to obtaining one or more large-scale parameters of the DL channel, the UE may estimate the CSI of the DL channel corresponding to the selected new beam, beam pair or link based on the CSIA-RS that is associated with the BM-RS and/or T-RS of the selected new beam, beam pair or link. The CSI may include information pertaining to one or more of RI, CQI, PMI, and LI. Based on the estimated CSI, the UE may initiate link switching for the selected new beam, beam pair, or link by sending a feedback report to the base station. The feedback report may include feedback information such as an indication of one or more of the BM-RS, T-RS, and CSIA-RS for the selected new beam, beam pair, or link and the corresponding values of one or more of RSRP, SINR, RI, CQI, PMI, and LI.

In some embodiments, after a delay from initiating the beam switching or link switching, or from receiving a confirmation message from the base station for the beam switching or link switching, the UE may perform DL reception including physical downlink control channel (PDCCH) and physical downlink shared channel (PDSCH) using the selected beam or link. In some embodiments, after a delay from initiating the beam switching or link switching, or from receiving a confirmation message from the base station of the beam switching or link switching, the UE may perform UL transmission including physical uplink control channel (PUCCH) and physical downlink shared channel (PUSCH) using the selected beam or link. The delay from initiating the beam switching or link switching, or from receiving a confirmation message from the base station of the beam switching or link switching may be a pre-determined delay or a pre-configured delay.

In some embodiments, the UE may assume that the PDCCH and/or PDSCH that will be received at the UE is quasi co-located (QCL) with the selected T-RS and/or BM-RS and/or CSIA-RS in terms of QCL-TypeD. For example, the UE may apply a receive beam used for receiving the selected T-RS and/or BM-RS and/or CSIA-RS to receive PDCCH and/or PDSCH. In some embodiments, the UE may be provided an indication of the PDCCH and/or PDSCH being QCLed with one or more of the reference signals.

In some embodiments, the UE may transmit PUCCH and/or PUSCH using the selected BM-RS and/or T-RS and/or CSIA-RS as the source reference signal for determining a spatial transmit filter. For example, the UE may apply the same beam (if beam correspondence holds at the UE) or the corresponding transmit beam to transmit PUCCH and/or PUSCH (if beam correspondence does not hold at this UE and a mapping between the receive beam and the transmit beam are maintained). Beam correspondence refers to whether the UE beam selected for DL reception can also be used for UL transmission, i.e., whether the UE can use the same beam for DL reception and UL transmission.

In some embodiments, the association or mapping may be ordered such that BM-RS maps to CSIA-RS, and CSIA-RS maps to T-RS. In such embodiments, the UE performs beam selection based on BM-RS, and then obtains CSI based on CSIA-RS associated with BM-RS. The UE then tracks large-scale parameters of the DL channel for the selected new selected beam, beam pair, or link based on the T-RS that is associated with the BM-RS and/or CSIA-RS of the selected new beam, beam pair or link.

In some embodiments, the UE may track large-scale parameters of the DL channel from the selected BM-RS directly, and estimate the CSI of the DL channel under the selected new beam, beam pair, or link, based on the CSIA-RS that is associated with the selected BM-RS of the selected new beam, beam pair or link. In this case, the association or mapping configured for the UE is between BM-RS and CSIA-RS, and T-RS is not included.

In some embodiments, the UE may estimate the CSI of the DL channel of the selected new beam, beam pair or link, based on the BM-RS directly or based on the T-RS that is associated with the BM-RS. In such embodiments, the association or mapping configured for the UE is an association between BM-RS and T-RS, and CSIA-RS is not included in the association or mapping. When no CSIA-RS is associated with the other two RS types, the UE may estimate the CSI from the BM-RS of the selected new beam, beam pair, or link directly.

When the association between at least two of BM-RS, T-RS, and CSIA-RS are configured for the UE, the examples described above are possible implementations for the UE to measure and select a new beam, bam pair or link associated with at least one of BM-RS, T-RS, and/or CSIA-RS. It is to be understood that these examples are not intended to limit the association of the reference signals to a specific order of association of reference signal type for measurement at the UE. For example, instead of measuring T-RS first and then CSIA-RS, it would also be possible to measure CSIA-RS first and then T-RS.

FIG. 8 illustrates an example of communication between a base station (BS) 810 and UE 820. There are several functionalities shown occurring from left to right in FIG. 8. The arrangement of functionalities along a horizontal axis from left to right indicates the functionalities occurring at different and subsequent times. However, as indicated above, this arrange of functionalities is merely one example arrangement and other arrangements are possible.

It is to be understood that, as described above, the association or mapping is provided to the UE so the UE is aware of the association or mapping amongst the BM-RS, T-RS and/or CSIA-RS.

A first functionality is beam selection 830 of a new beam, beam pair or link. Each of the base station 810 and the UE 820 are shown utilizing three beams in a general direction. The UE 820 may perform measurements of the BM-RS and select a new beam pair 834, including a base station beam 834a and UE beam 834b, for possible eventual communication between the base station 810 and UE 820. The beam selection functionality may be performed based on the base station 810 sending an indication of BM-RS that may be measured at the UE 829 as described above. The base station 810 may have also sent an indication of an association of BM-RS, T-RS and/or CSIA-RS. The UE 820 may then use the selected new beam pair 834 to perform measurements of other types of reference signals in the association in subsequent functionalities such as channel tracking 840 and CSI acquisition 850.

The second functionality is channel tracking 840. Based on the association 805 of BM-RS and T-RS, the UE 820 starts tracking large-scale parameters of the DL channel corresponding to the selected new beam, beam pair, or link based on the T-RS that is associated with the selected BM-RS on UE beam 834b.

The third functionality is CSI acquisition 850. Subsequent to obtaining one or more large-scale parameters of the DL channel, based on the association 805 of T-RS and CSIA-RS, the UE 820 measures and estimates the CSI of the DL channel on the UE beam 834b based on the CSIA-RS that is associated with the BM-RS and/or T-RS.

A fourth functionality is CSI reporting 860. Based on the estimated CSI obtained in the CSI acquisition functionality 850, the UE 820 may initiate beam switching, beam pair switching, or link switching from an active beam, beam pair, or link to the selected new beam, beam pair, or link by sending 865 feedback information to the base station 810, which may include an indication of one or more of the BM-RS, T-RS, and CSIA-RS of the selected new beam, beam pair, or link and the corresponding parameter values of one or more of RSRP, SINR, RI, CQI, PMI, and LI.

A fifth, and optional, functionality is base station 810 performing beam switching, beam pair switching, or link switching confirmation 870. The base station 810 may send 875 confirmation that the base station 810 has received the UE feedback information 865.

A sixth functionality is QCL update 880. As described above, the UE 820 may assume PDCCH and/or PDSCH reception is quasi-co-located (QCLed) with one or more of the reported BM-RS, T-RS, and CSIA-RS in terms of QCL-TypeD. While a single arrow 885 is shown between the channel tracking functionality indicating that the PDCCH and/or PDSCH reception is QCLed with T-RS, it is to be understood that the PDCCH and/or PDSCH reception may be QCLed with either the BM-RS or CSIA-RS as well.

In some embodiments, the UE 820 may repeat the process of measuring the reference signals during the various functionalities of beam selection 830, channel tracking 840 and CSI acquisition 850, based on the association of at least two of BM-RS, T-RS, and CSIA-RS in a continuous manner. For example, when the UE is moving, the UE may continue to perform the measurements at any desirable manner, periodic, aperiodic, or sporadic, to determine if there is an alternative new beam, beam pair, or link that may be preferred to the current beam, beam pair, or link.

In a particular example, when one BM-RS (e.g., associated with one wide beam) is associated with multiple T-RS (e.g., associated with multiple narrow beams), if the selected BM-RS is the same (e.g., same wide beam) and a new T-RS is selected (e.g., new narrow beam), the UE may still initiate link switching towards the selected T-RS (e.g., newly selected narrow beam) via sending a report to the base station, which may include an indicator of one or more of the BM-RS, T-RS, and/or CSIA-RS associated with the selected new beam, beam pair, or link, as well as corresponding RSRP, SINR, RI, CQI, PMI, and/or LI. While wide beams and narrow beams are mentioned in the examples above, it is to be understood that this is not intended to be limiting. Generally a wide beam covers a larger angular range than a narrow beam.

In another particular example, when one T-RS (e.g., associated with one wide beam) is associated with multiple CSIA-RS (e.g., associated with multiple narrow beams), when one of the multiple CSIA-RS is selected (e.g., new narrow beam), the UE may initiate link switching towards the selected CSIA-RS via sending a report to the base station, which may include an indicator of one or more of the BM-RS, T-RS, and/or CSIA-RS associated with the selected new beam, beam pair, or link, as well as corresponding RSRP, SINR, RI, CQI, PMI, and/or LI.

A preferred new beam, beam pair, or link can be determined based on measurement results from one or more of BM-RS, T-RS, and/or CSI-RS. In the examples above, the preferred new beam, beam pair, or link is determined based on measurement of such parameters as RSRP or SINR, or CSI of the DL channel for the selected new beam, beam pair, or link. In addition to those parameters, it may also be possible to determine the preferred new beam, beam pair, or link based on multiple measurement results. For example, the UE may select a new beam, beam pair, or link with a lowest Doppler shift or Doppler spread among those with RSRP or SINR above a certain threshold. The UE may select a new beam, beam pair, or link with a highest predicted data rate calculated from measured CSI (including RI and CQI) among those with RSRP or SINR above a certain threshold. The UE may select a new link with highest predicted data rate calculated from measured CSI (including RI and CQI) among those with RSRP or SINR above a certain threshold and Doppler shift or Doppler spread below a certain threshold.

The association between two or more of BM-RS, T-RS, and CSIA-RS described above may be provided to the UE by configuration signaling. In some embodiments, the configuration signaling may be a similar configuration signaling that is used to inform a QCL relation between reference signals. For example, the base station may notify the UE that the BM-RS, T-RS, and CSIA-RS are one-to-one mapped or associated (as shown in FIG. 5) and the UE may derive the association based on the configured QCL relation among these reference signals (e.g., CSIA-RS #1 is QCLed to T-RS #1, and TRS #1 is QCLed to BM-RS #1).

In some embodiments, the association may be pre-defined, and may be assumed by a UE, without relying on either explicit or implicit signaling from the base station. When the association is provided to the UE or is pre-defined, the UE may store a look-up table that includes the association between two or more of BM-RS, T-RS, and CSIA-RS and subsequently check the stored look-up table during the UE-initiated beam switching, beam pair switching, or link switching process. In some embodiments, the base station may send configuration signaling to update the association stored at the UE. The update to the association may be an update to the whole association table or an update to a part of the table, such as one or multiple entries in the table, but not all entries.

In some embodiments, the latency and overhead resulting from channel tracking and CSI acquisition may be reduced, leading to faster and smoother link adaptation in a multi-beam system with UE-initiated beam management, beam pair management, or link management.

In some embodiments, the base station and the UE exchange information to enable the UE and base station to have aligned understanding of possible beam, beam pair, link prediction behavior at each side of the link. In particular, the base station may send configuration information to indicate whether the UE is allowed or forbidden to perform beam prediction, beam pair prediction, or link prediction that may involve reporting a beam, beam pair, or link that is predicted to have adequate link quality at a given time in the future, together with an expected link quality such as RSRP, SINR, RI, CQI, PMI, and/or LI. Such configuration information may further include an indication of an allowed time frame for the UE to predict beam quality, beam pair quality, or link quality, which informs the UE of the time range that the UE is allowed to use beam prediction, beam pair prediction, or link prediction as part of link selection. The indication of the time range may be expressed in the format of a number of frames, slots, or symbols, or a step size (e.g., 1, 2, 4, or 8 slots) and a number of steps (e.g., multiple of step size). The base station may indicate a reference point in time for the indicated time range, i.e., from which point the time range is counted. The reference point in time may be the latest measurement occasion or the time instance at which the feedback information is to be sent to the base station. In this way, the base station can be assured about the possible time frame where the selected new beam, beam pair, or link has the predicted link quality.

In some embodiments, the base station may additionally send configuration information to the UE to configure a threshold value based on a particular confidence level to the UE, where the UE is expected to report a predicted beam, beam pair, or link only if the UE is confident that the prediction is accurate within the configured confidence level.

Feedback information sent from the UE to the base station may include an indication of whether the selected new beam, beam pair, or link and corresponding link quality are based on a prediction or not. In some embodiments, when the UE reports a selected new beam, beam pair, or link based on predicted link quality, such as RSRP, SINR, RI, CQI, PMI, and/or LI, the UE may be configured to send feedback information that identifies an instance in time when the beam, beam pair, or link is predicted to have the corresponding link quality. Such time instance information may be reported in reference to the latest measurement occasion of BM-RS, T-RS, and/or CSIA-RS, or an instance in time at which the feedback information is to be sent by the UE or the reference point may be reported by the UE. Relative to the configured or reported reference point in time, the time offset for the predicted beam, beam pair, or link and corresponding quality may be expressed in the format of a number of frames, slots or symbols or a step size (e.g., 1, 2, 4, or 8 slots) and a number of steps (e.g., multiple of step size).

In some embodiments, the feedback information from the UE to the base station may include a calculated confidence level for the predicted link quality.

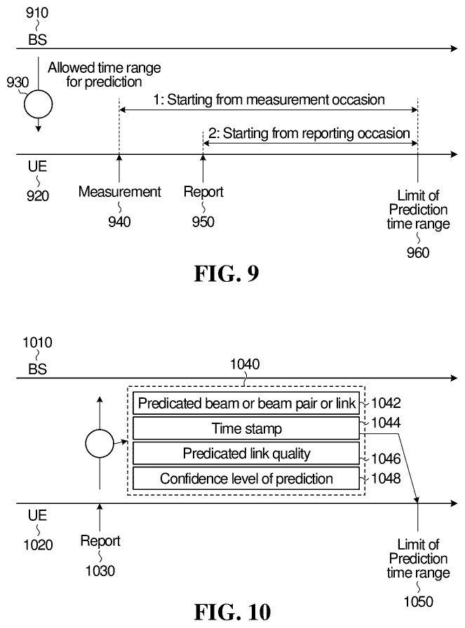

FIG. 9 illustrates an example of how prediction may be used as part of a beam, beam pair, or link selection process. FIG. 9 illustrates a signal being sent from a base station 910 to a UE 920. The signal may include an indication of the time range that may be used by the UE 920 as part of the prediction for beam selection, beam pair selection, or link selection. The horizontal axis provides an indication of increasing time from left to right. A limit of the time range for prediction 960 is shown in FIG. 9. The indication of the time range sent by the base station 910 may be in reference to the latest measurement occasion 940 of BM-RS, T-RS, and/or CSIA-RS, or an instance in time at which the report is to be sent 950 by the UE to the base station.

FIG. 10 illustrates another example of how prediction may be used as part of a beam, beam pair, or link selection process. FIG. 10 illustrates a signal being sent from a UE 1020 to a base station 1010. The horizontal axis provides an indication of increasing time from left to right. The signal may include feedback information 1040 such as one or more of an indication of the selected new beam, beam pair or link 1042, a time stamp 1044 indicating the time instance of the predicted link quality 1050, a predicted link quality 1046, and a confidence level of the prediction 1048.

In embodiments pertaining to a multi-beam systems where the UE is allowed to perform predication as a part of beam selection, beam pair selection, or link selection and report the selected beam, beam pair, or link, the base station may have improved knowledge and control of beam, beam pair, or link prediction behavior at the UE, leading to an improved coordination and operating efficiency.

In some embodiments, the UE initiates beam switching, beam pair switching, or link switching based on predicted beam quality, beam pair quality, or link quality. For example, if a new beam, beam pair, or link is predicted to be better than the active beam, beam pair or link at a future time instance, the UE may send feedback information including information such as the selected new beam, beam pair or link, the predicted link quality, and/or the corresponding time instance of the link quality prediction to the base station, to initiate link switching based on the selected new beam, beam pair, or link. The beam selection, channel tracking, CSI acquisition, switching process, and/or the beam, beam pair, or link prediction methods at the UE may follow steps described in previous embodiments. For a new beam, beam pair, or link to be better than the active beam, beam pair, or link, such comparison can be based on the link quality, including parameters such as RSRP, SINR, RI, CQI, etc.

In some embodiments, the feedback information may be carried over an UL transmission resource requested by the UE and then scheduled by the base station. For example the feedback information may be sent in a PUSCH. In some embodiments, the feedback information may be carried over a periodic and semi-persistent UL transmission configured by the base station. For example the feedback information may be sent in periodic PUCCH transmission. In some embodiments, the feedback information may be carried over a configured grant based UL transmission.

In some embodiments, the feedback information may be carried in uplink control information (UCI) and/or media access control-control element (MAC-CE). For example, the UE may be configured to perform periodic reporting. In some embodiments, in addition to periodic reporting, the UE may request one or more aperiodic UL transmission opportunity, which are separate from the periodic reporting instances, to inform the base station about the selected new beam, beam pair or link, the predicted link quality, and/or the corresponding time instance for the link quality. In some embodiments, the aperiodic UL transmission from the UE to the base station may request aperiodic transmission of T-RS and/or CSIA-RS at a time instance indicated in the request, which may help increase the speed of the overall link adaptation at the UE. In some embodiments, the aperiodic UL transmission from the UE to the base station may request aperiodic transmission of T-RS and/or CSIA-RS after certain delay that is considered to start from the UL transmission or the time instance indicated in the report.

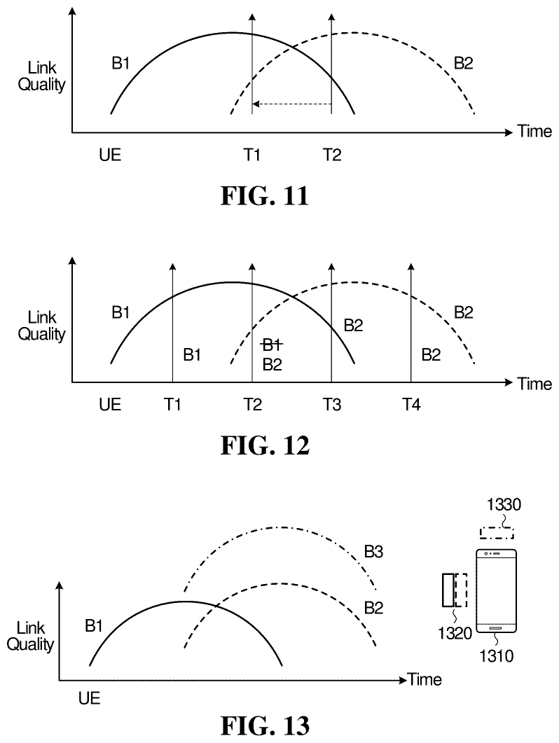

FIG. 11 illustrates a graphical plot that is an example of received power at a UE for two different base station beams B1 and B2 as the UE is moving. The horizontal axis of the plot is increasing time moving from left to the right. The vertical axis is measured link quality, such as RSRP, SINR, RI, and/or CQI. The measured link quality of base station beam B1 increases and then decreases. The measured link quality of base station beam B2 increases and then decreases. There is a period of time between a first instance of time T1 and a second instance of time T2 in which as the link quality of base station beam B1 is decreasing and the link quality of base station beam B2 is increasing. If the UE initiates beam, beam pair or link switching at the second instance of time T2 after observing that base station beam B2 has a better link quality than beam B1, it then takes additional time to finish the beam switching process after T2. In some embodiments, the UE initiates link switching at an earlier instance of time, such as at T1 or shortly thereafter, where the measured link quality of base station beam B2 may still be worse than base station beam B1, but it is predicted to be better shortly thereafter. In other words, the UE initiates the link switching process based on predicting link quality at a future time instance. In this way, the UE and base station may start the link switching process at an earlier time, and performance degradations during the transition region may be reduced. In some embodiments, the UE may initiate link switching when the predicted link quality for base station beam B2 is better than that of base station beam B1 by a particular margin or threshold. Such a margin or threshold or margin may be pre-determined or configured by the base station.

In some embodiments, the UE may determine whether to initiate link switching based on how fast the link quality is changing. For example, when the link quality of base station beam B1 is dropping slowly and/or that of base station beam B2 is improving slowly, there may not be a strong motivation for the UE to initiate predictive beam switching, beam pair switching, or link switching and the UE may choose not to initiate link switching. However, when the link quality of base station beam B1 is dropping rapidly and/or that of base station beam B2 is improving rapidly, the UE may initiate predictive link switching for faster link adaptation and/or to avoid link outage.

Referring back to FIG. 11, the UE may initiate reporting of feedback information and thereby link switching at an UL transmission occasion. In some embodiments, the reporting occasions are pre-configured by the base station and appear periodically. FIG. 12 illustrates another graphical plot that is an example of received power at a UE for two different base station beams B1 and B2 as the UE is moving. The horizontal and vertical axis are similar to the axes in FIG. 11. The base station beams B1 and B2 have a similar measured link quality pattern over time as in FIG. 11. Examples of periodic reporting instances in time that are pre-configured by the base station are denoted in FIG. 12 as T1, T2, T3, T4. While the measured link quality of base station beam B1 may be better than base station beam B2 at T2, the UE may provide feedback information indicating that base station beam B2 (as indicated by “ [symbol] ” and “B2” by the vertical arrow at T2) is preferred for link switching, and the predicted link quality at the reporting instance of T2, if the link quality for base station beam B2 is expected to become better and exceed base station beam B1 after some time and/or by a certain margin. In the feedback information that is sent at T2, the UE may indicate whether the selected new beam, beam pair, or link and associated link quality are predicted or not. As a result, the UE may initiate switching to base station beam B2 at T2 instead of at T3 when base station beam B2 has a better measured link quality. Initiating link switching based on the predicted link quality may help reduce performance degradations during a transition region. In some embodiments, the UE may decide whether to initiate predictive link switching based on one or more of: a predicted difference between a new beam, beam pair or link and the active beam, beam pair or link at a future time instance; a threshold on such predicted difference; reporting periodicity; and confidence level for such prediction (e.g., whether BS beam B2 is expected to be 3 dB better than base station beam B1 at T3 in terms of RSRP or SINR, with a confidence level of 90%).

While the examples of FIGS. 11 and 12 are described in terms two beams, beam pairs, or links, it should be understood that the same methods may occur for more than two beams, beam pairs, or links simultaneously.

In some embodiments, a UE may be allowed to initiate predictive link switching in multi-beam systems, with which the performance degradations during transition region may be reduced and the process of UE-initiated beam switching, beam pair switching, or link switching may be smoothed.

In some embodiments, the UE may select a new beam, beam pair, or link based on smoothness of a transition from an active beam, beam pair, or link to the new beam, beam pair or link. For example, the UE may select a new beam, beam pair, or link having a link quality that is within a margin or threshold of the link quality of the active beam, beam pair, or link. In this way, during the transition from the active beam, beam pair or link to the selected new beam, beam pair, or link, performance fluctuations may be reduced. In some embodiments, for a UE having multiple antenna panels, considering the link quality of multiple beams, beam pairs, or links may result in the UE selecting a different receive beam from the same antenna panel, as opposed to selecting a receive beam from a different antenna panel, because the beams, beam pairs, or links on the same antenna panel have a smooth transition due to their similar configuration and/or orientation.

FIG. 13 illustrates a graphical plot that is an example of received power at a UE for three different BS beams B1, B2 and B3 as the UE is moving. BS beams B1 and B2 are beams that are received with a same antenna panel 1320 of UE 1310 and BS beam B3 is a beam received with a different antenna panel 1330 of UE 1310. The horizontal and vertical axis are similar to the axes in FIG. 11. In the example in FIG. 13, as the UE moves from left to the right, despite BS beam B3 having a higher link quality, the UE 1320 may select BS beam B2 instead of BS beam B3, as the measured quality of BS beam B2 is closer to that of BS beam B1, such that a smooth transition is achieved from BS beam B1 to BS beam B2.

In some embodiments, a UE may be enabled to select a beam, beam pair, or link based on smoothness of a transition from the active beam, beam pair, or link to the new beam, beam pair, or link, so that smoothness of beam tracking, beam pair tracking, or link tracking may be improved.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
receiving an indication of an association between at least two of: a beam measurement reference signal (BM-RS); a tracking reference signal (T-RS); or a channel state information acquisition reference signal (CSIA-RS);
selecting a new link for link switching based on measurements of at least one of the BM-RS, the T-RS, or the CSIA-RS; and
transmitting an indication of the link switching that includes an indication of the new link and feedback information pertaining to the new link based on the measurements of the at least one of the BM-RS, the T-RS, or the CSIA-RS.

2. The method of claim 1, further comprising:
performing measurements of the at least two of the BM-RS, the T-RS, or the CSIA-RS based on the indication of the association.

3. The method of claim 2, wherein:
performing measurements of the BM-RS comprises measuring the BM-RS and determining a reference signal received power (RSRP) or a signal-to-interference-plus-noise ratio (SINR);
performing measurements of the T-RS comprises tracking the T-RS and determining large-scale parameters of a channel for the new link on which the T-RS is monitored, wherein the large-scale parameters include one or more of: an average delay; a delay spread; a Doppler shift; or a Doppler spread; or
performing measurements of the CSIA-RS comprises estimating channel state information (CSI) of a channel for the new link on which the CSIA-RS is received based on one or more of: a rank indicator (RI); a channel quality indicator (CQI); a precoding matrix indicator (PMI); or a layer indicator (LI).

4. The method of claim 1, further comprising:
updating a physical downlink control channel (PDCCH) quasi co-location (QCL) or a physical downlink shared channel (PDSCH) QCL based on the new link.

5. The method of claim 1, wherein the selecting the new link for the link switching comprises one of:
selecting a link with a lowest Doppler shift among Doppler shifts of candidate links or a lowest Doppler spread among Doppler spreads of the candidate links with a corresponding RSRP or a corresponding SINR above a first threshold value;
selecting a link with a highest predicted data rate determined from measured CSI among candidate links with the corresponding RSRP or the corresponding SINR above the first threshold value;
selecting a link with the highest predicted data rate determined from the measured CSI among the candidate links with the corresponding RSRP or the corresponding SINR above the first threshold value and a corresponding Doppler shift or a corresponding Doppler spread below a second threshold value; or
selecting a link with a highest measured RSRP or SINR or RI or CQI.

6. The method of claim 1, further comprising:
determining the association between at least two of the BM-RS, T-RS, or the CSIA-RS based on the indication of the association.

7. The method of claim 6, wherein the indication of the association includes at least one of:
an indication that the T-RS is quasi co-located (QCLed) to the BM-RS; or
an indication that a UE derives association for UE-initiated link switching based on already indicated QCL relations.

8. A method comprising:
transmitting an indication of an association between at least two of: a beam measurement reference signal (BM-RS); a tracking reference signal (T-RS); or a channel state information acquisition reference signal (CSIA-RS); and
receiving, from a user equipment (UE), an indication of link switching that includes an indication of a new link and feedback information pertaining to the new link based on measurements of at least one of the BM-RS, the T-RS, or the CSIA-RS.

9. The method of claim 8, wherein the indication of the association between the at least two of the BM-RS, T-RS, or the CSIA-RS is:
an explicitly disclosed association between the at least two of the BM-RS, the T-RS, or the CSIA-RS; or
an implicitly disclosed association between the at least two of the BM-RS, the T-RS, or the CSIA-RS to be used by the UE to determine the association between the at least two of the BM-RS, the T-RS, or the CSIA-RS.

10. The method of claim 9, wherein the implicitly disclosed association comprises at least one of:
an indication that the T-RS is quasi co-located (QCLed) to the BM-RS; or
an indication that the UE derives association for UE-initiated link switching based on already indicated QCL relations.

11. An apparatus comprising:
one or more processors, when executing program instructions stored in the apparatus, cause the apparatus to:
receive an indication of an association between at least two of: a beam measurement reference signal (BM-RS); a tracking reference signal (T-RS); or a channel state information acquisition reference signal (CSIA-RS);
select a new link for link switching based on measurements of at least one of the BM-RS, the T-RS, or the CSIA-RS; and
transmit an indication of the link switching that includes an indication of the new link and feedback information pertaining to the new link based on the measurements of the at least one of the BM-RS, the T-RS, or the CSIA-RS.

12. The apparatus of claim 11, wherein the one or more processors further cause the apparatus to:
perform measurements of the at least two of the BM-RS, the T-RS, or the CSIA-RS based on the indication of the association.

13. The apparatus of claim 12, wherein:
performing measurements of the BM-RS comprises measuring the BM-RS and determining a reference signal received power (RSRP) or a signal-to-interference-plus-noise ratio (SINR);
performing measurements of the T-RS comprises tracking the T-RS and determining large-scale parameters of a channel for the new link on which the T-RS is monitored, wherein the large-scale parameters include one or more of: an average delay; a delay spread; a Doppler shift; or a Doppler spread; or
performing measurements of the CSIA-RS comprises estimating channel state information (CSI) of a channel for the new link on which the CSIA-RS is received based on one or more of: a rank indicator (RI); a channel quality indicator (CQI); a precoding matrix indicator (PMI); or a layer indicator (LI).

14. The apparatus of claim 11, wherein the one or more processors further cause the apparatus to:
update a physical downlink control channel (PDCCH) quasi co-location (QCL) or a physical downlink shared channel (PDSCH) QCL based on the new link.

15. The apparatus of claim 11, selecting the new link for the link switching comprises one of:
selecting a link with a lowest Doppler shift among Doppler shifts of candidate links or a lowest Doppler spread among Doppler spreads of the candidate links with RSRP or SINR above a threshold value;
selecting a link with a highest predicted data rate determined from measured CSI among candidate links with a corresponding RSRP or a corresponding SINR above a first threshold value;
selecting a link with the highest predicted data rate determined from the measured CSI among the candidate links with the corresponding RSRP or the corresponding SINR above the first threshold value and a corresponding Doppler shift or a corresponding Doppler spread below a second threshold value; and
selecting a link with a highest measured RSRP or SINR or RI or CQI.

16. The apparatus of claim 11, wherein the one or more processors further cause the apparatus to:
determine the association between at least two of the BM-RS, T-RS, or the CSIA-RS based on the indication of the association.

17. The apparatus of claim 16, wherein the indication of the association includes at least one of:
an indication that the T-RS is quasi co-located (QCLed) to the BM-RS; or
an indication that the apparatus derives association for apparatus-initiated link switching based on already indicated QCL relations.

18. An apparatus comprising:
one or more processors, when executing program instructions stored in the apparatus, cause the apparatus to:
transmit an indication of an association between at least two of: a beam measurement reference signal (BM-RS); a tracking reference signal (T-RS); or a channel state information acquisition reference signal (CSIA-RS); and
receive, from a user equipment (UE), an indication of link switching that includes an indication of a new link and feedback information pertaining to the new link based on measurements of at least one of the BM-RS, the T-RS, or CSIA-RS.

19. The apparatus of claim 18, wherein the indication of the association between the at least two of the BM-RS, T-RS, or the CSIA-RS is:
an explicitly disclosed association between the at least two of the BM-RS, the T-RS, or the CSIA-RS; or
an implicitly disclosed association between the at least two of the BM-RS, the T-RS, or the CSIA-RS to be used by the UE to determine the association between the at least two of the BM-RS, the T-RS, or the CSIA-RS.

20. The apparatus of claim 19, wherein the implicitly disclosed association comprises at least one of:
an indication that the T-RS is quasi co-located (QCLed) to the BM-RS; or
an indication that the UE derives association for UE-initiated link switching based on already indicated QCL relations.
